(19) United States
(12) Patent Application Publication
(10) Pub. No.: US 2025/0289345 A1
(43) Pub. Date: Sep. 18, 2025

(54) POWER SUPPLY DEVICE AND ECO-FRIENDLY VEHICLE INCLUDING THE SAME

(71) Applicants: Hyundai Motor Company, Seoul (KR); Kia Corporation, Seoul (KR)

(72) Inventors: Byeong Seob Song, Suwon-si (KR); Bo Kyung Yoon, Incheon (KR); Hae Seung Lee, Yongin-si (KR); Ho Young Jung, Incheon (KR)

(21) Appl. No.: 18/812,257

(22) Filed: Aug. 22, 2024

(30) Foreign Application Priority Data
Mar. 14, 2024 (KR) 10-2024-0035919

(51) Int. Cl. B60L 55/00; B60L 53/10; B60L 53/16

(52) U.S. Cl. CPC B60L 55/00; B60L 53/11; B60L 53/16; B60L 2210/10; B60L 2210/42

(57) ABSTRACT

An embodiment power supply device of an eco-friendly vehicle includes a low voltage supply module, an inlet including a plurality of terminals for fast charging and slow charging, wherein, among the plurality of terminals, a terminal connected to the low voltage supply module is an alternating current (AC) input terminal for slow charging, a first switching module disposed between a first terminal of the plurality of terminals and the low voltage supply module, and a control module configured to turn on the first switching module to supply a control voltage from the low voltage supply module to an external device in a state in which a connector of the external device is connected to the inlet.

### CROSS-REFERENCE TO RELATED APPLICATIONS

This application claims the benefit of Korean Patent Application No. 10-2024-0035919, filed on Mar. 14, 2024, which application is hereby incorporated herein by reference.

### TECHNICAL FIELD

The present disclosure relates to a power supply device and an eco-friendly vehicle including the same.

### BACKGROUND

Recently, research has been conducted on increasing the battery capacity of eco-friendly vehicles (e.g., a plug-in hybrid electric vehicle (PHEV) or an electric vehicle (EV)) and various technologies related thereto. Thereamong is vehicle-to-everything (V2X) technology including vehicle-to-load (V2L), vehicle-to-vehicle (V2V), and vehicle-to-grid (V2G), and according to the V2X technology, an electric vehicle may be used as an auxiliary battery. These technologies use on-board chargers (OBCs).

However, when implementing V2X technology using an external charger (an off-board charger), it is necessary to supply control power from a vehicle to the external charger, but current charging connector standards (e.g., CCS1 and CCS2) do not regulate terminals for supplying the control power to the external charger.

In addition, in the case of eco-friendly vehicles equipped with a low capacity (e.g., 7 kW) OBC, a high capacity (e.g., 22 kW) external charger capable of charging at high power may not be used, and if the OBC breaks down, slow charging may not be performed.

### SUMMARY

An embodiment of the present disclosure provides a power supply device capable of providing control power to an external device, charging a high-voltage battery mounted on an eco-friendly vehicle with high power through an external device, regardless of whether an on-board charger (OBC) is provided or broken, and supplying high voltage of the high voltage battery mounted on the eco-friendly vehicle to a load through an external device, and an eco-friendly vehicle including the same.

According to an embodiment of the present disclosure, a power supply device of an eco-friendly vehicle includes a low voltage supply module supplying a control voltage, an inlet including a plurality of terminals for fast charging and slow charging, a first switching module provided between one of the plurality of terminals and the low voltage supply module, and a control module turning on the first switching module to supply the control voltage to an external device, when a connector of the external device is connected to the inlet, wherein, among the plurality of terminals, a terminal connected to the low voltage supply module is an AC input terminal for slow charging.

The inlet may further include a fastening confirmation terminal, and the control module may be configured to turn on the first switching module when it is confirmed that the inlet and the connector of the external device are connected through the fastening confirmation terminal.

The inlet may further include a communication terminal, and the control module may be configured to control a locking device to lock the inlet and the connector of the external device when it is confirmed that communication with the external device is normal, through the communication terminal.

The power supply device may further include a high voltage supply module supplying a high voltage and a second switching module provided between the high voltage supply module and a DC input terminal for fast charging among the plurality of terminals, wherein the control module is configured to turn on the second switching module to supply the high voltage to the external device, when a request for high voltage is received through the communication terminal.

The control module may be configured to turn off the first switching module and the second switching module and then control the locking device to unlock the inlet and the connector of the external device, when a request for termination of the control voltage is received through the communication terminal.

The control module may be configured to sequentially turn off the second switching module and the first switching module when the request for termination of the control voltage is received.

The low voltage supply module may be an auxiliary battery supplying 12 V or 24 V voltage or a low DC-DC converter (LDC) receiving a high voltage from the high voltage supply module and converting the received high voltage into 12 V or 24 V voltage.

The external device may be a DC/AC converter converting a high voltage of the high voltage supply module into AC voltage and supplying the AC voltage to an external load or a DC/DC converter stepping up or stepping down the high voltage of the high voltage supply module and supplying the corresponding voltage to an external load.

The external load may include a load for vehicle-to-everything (V2X).

The external device may be an AC/DC converter converting AC voltage to DC voltage, and the converted DC voltage may be configured to directly charge the high voltage supply module through the DC input terminal.

The inlet of the eco-friendly vehicle may be compliant with charging connector standards of either CCS1 or CCS2.

In the case of CCS1, when any one of an L1 terminal and an L2/N terminal constituting the AC input terminal is connected to a positive (+) terminal of the low voltage supply module, a negative (−) terminal of the low voltage supply module may be connected to a PE terminal, the DC input terminals may be DC+ and DC− terminals, the fastening confirmation terminal may be a PD terminal, and the communication terminal may be a CP terminal.

In the case of CCS1, when any one of an L1 terminal and an L2/N terminal constituting the AC input terminal is connected to the positive (+) terminal of the low voltage supply module, the negative (−) terminal of the low voltage supply module may be connected to the other of the L1 terminal and the L2/N terminal, the first switching module may be provided between any one of the L1 terminal and the L2/N terminal and the positive (+) terminal of the low voltage supply module and between the other of the L1 terminal and L2/N terminal and the negative (−) terminal of the low voltage supply module, the DC input terminals may be DC+ and DC− terminals, the fastening confirmation terminal may be a PD terminal, and the communication terminal may be a CP terminal.

In the case of CCS2, when the AC input terminal is one of the L1 terminal, the L2 terminal, and an L3 terminal, the negative (−) terminal of the low voltage supply module may be connected to the PE terminal, the DC input terminals may be DC+ and DC− terminals, the fastening confirmation terminal may be the PD terminal, and the communication terminal may be the CP terminal.

The control voltage may be a DC voltage between 12 V and 48 V, and the high voltage may be a DC voltage between 400 V and 800 V.

According to another embodiment of the present disclosure, an eco-friendly vehicle includes a power supply module, wherein the power supply module includes a low voltage supply module supplying a control voltage, an inlet including a plurality of terminals for fast charging and slow charging, a first switching module provided between one of the plurality of terminals and the low voltage supply module, and a control module turning on the first switching module to supply the control voltage to an external device, when a connector of the external device is connected to the inlet, wherein, among the plurality of terminals, a terminal connected to the low voltage supply module is an AC input terminal for slow charging.

The inlet may further include a fastening confirmation terminal, and the control module may be configured to turn on the first switching module when it is confirmed that the inlet and the connector of the external device are connected through the fastening confirmation terminal.

The inlet may further include a communication terminal, and the control module may be configured to control a locking device to lock the inlet and the connector of the external device when it is confirmed that communication with the external device is normal through the communication terminal.

The eco-friendly vehicle may further include a high voltage supply module supplying a high voltage and a second switching module provided between the high voltage supply module and a DC input terminal for fast charging among the plurality of terminals, wherein the control module is configured to turn on the second switching module to supply the high voltage to the external device, when a request for high voltage is received through the communication terminal.

When the inlet of the eco-friendly vehicle complies with charging connector standards of CCS1 and any one of the L1 terminal and the L2/N terminal constituting the AC input terminal is connected to the positive (+) terminal of the low voltage supply module, the negative (−) terminal of the low voltage supply module may be connected to the PE terminal, the DC input terminals may be DC+ and DC− terminals, the fastening confirmation terminal may be the PD terminal, and the communication terminal may be the CP terminal.

### BRIEF DESCRIPTION OF THE DRAWINGS

The above and other aspects, features, and advantages of embodiments of the present disclosure will be more clearly understood from the following detailed description, taken in conjunction with the accompanying drawings, in which:

FIG. 1 is a diagram illustrating the entire system including a power supply device mounted on an eco-friendly vehicle according to an exemplary embodiment of the present disclosure;

FIG. 2 is a diagram illustrating a terminal configuration of CCS1 and CCS2 among the charging connector standards;

FIG. 3A is an internal block diagram of a power supply device for an eco-friendly vehicle equipped with an OBC according to an exemplary embodiment of the present disclosure;

FIG. 3B is an internal block diagram of a power supply device for an eco-friendly vehicle not equipped with an OBC according to an exemplary embodiment of the present disclosure;

FIG. 4 is a diagram illustrating an operation of a first switching module when supplying a control voltage to an external device according to an exemplary embodiment of the present disclosure;

FIG. 5A is a diagram illustrating that an eco-friendly vehicle equipped with an OBC supplies a high voltage to an external device or the external device charges a high voltage supply module;

FIG. 5B is a diagram illustrating that an eco-friendly vehicle not equipped with an OBC supplies a high voltage to an external device or the external device charges a high voltage supply module;

FIG. 6 is a flowchart illustrating a power supply method of an eco-friendly vehicle according to an exemplary embodiment of the present disclosure; and

FIG. 7 is a block diagram of a computing device that may fully or partially implement a control module according to an exemplary embodiment of the present disclosure.

### DETAILED DESCRIPTION OF ILLUSTRATIVE EMBODIMENTS

Hereinafter, exemplary embodiments of the present disclosure are described with reference to the accompanying drawings. The following description is provided to aid in the comprehensive understanding of methods, devices, and/or systems disclosed in the particularities. However, the following description is merely exemplary and is not provided to limit the present disclosure.

In the following description of embodiments of the present disclosure, a detailed description of known functions and configurations incorporated herein will be omitted when it would render the subject matter of the present disclosure unclear. The terms used in the present specification are defined in consideration of functions used in the present disclosure and may be changed according to the intent or conventionally used methods of clients, operators, and users. Accordingly, definitions of the terms should be understood on the basis of the entire description of the present specification. Terms used in the following description are merely provided to describe exemplary embodiments of the present disclosure and are not intended to be limiting of the inventive concept. As used herein, the singular forms “a,” “an” and “the” are intended to include the plural forms as well, unless the context clearly indicates otherwise. It will be further understood that the terms “comprises” or “has” when used in this specification specify the presence of stated features, integers, steps, operations, elements, or a portion or combination thereof, but they do not preclude the presence or addition of one or more other features, integers, steps, operations, elements, or a portion or combination thereof.

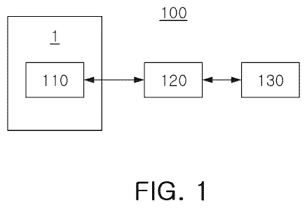

FIG. 1 is a diagram illustrating a system including a power supply device mounted on an eco-friendly vehicle according to an exemplary embodiment of the present disclosure. A system 100 may include a power supply device 110 mounted on an eco-friendly vehicle 1, an external device 120, and a load 130.

First, in embodiments of the present disclosure, an eco-friendly vehicle is a vehicle based on electric power and may refer to a vehicle including an inlet for charging a high voltage supply module mounted therein with an external power source, such as an electric vehicle (EV), a plug-in hybrid electric vehicle (PHEV), etc.

In addition, the external device 120 is a device requiring a control voltage for an operation and may be portable or fixed. If the external device 120 is portable, the external device may be shared and used by multiple users and may also be used at home, contributing to user convenience.

The external device 120 may be a direct current (DC)/alternating current (AC) converter converting a DC voltage supplied by the power supply device 110 into an AC voltage and supplying the same to the load 130, or it may be a DC/DC converter stepping up or stepping down a DC voltage and supplying the same to the load 130. In this case, the load 130 may be a load for vehicle-to-everything (V2X).

For example, in a case in which a V2X is a vehicle-to-load (V2L) or a vehicle-to-home (V2H), the load 130 may be various electronic devices, in a case in which the V2X is a vehicle-to-vehicle (V2V), the load 130 may be an eco-friendly vehicle, and in a case in which the V2X is a vehicle-to-grid (V2G), the load 130 may be a power grid.

Alternatively, the external device 120 may be an AC/DC converter converting AC voltage to DC voltage, and the power supply device 110 may be slowly charged by the converted DC voltage. In this case, the load 130 may be a power grid.

Meanwhile, the power supply device 110 may include an inlet including a plurality of terminals for fast charging and slow charging according to the charging connector standards.

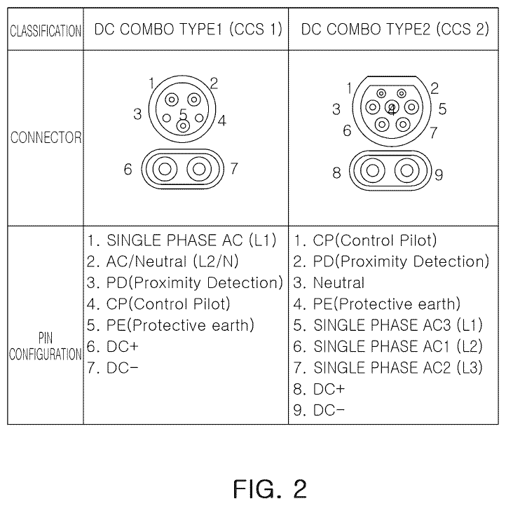

FIG. 2 is a diagram illustrating a terminal (pin) configuration of CCS1 and CCS2 among the charging connector standards. CCS1 may be referred to as DC combo type 1, and CCS2 may be referred to as DC combo type 2.

As shown in FIG. 2, according to CCS1, two AC input terminals L1 and L2/N, a proximity detection (PD) terminal, a control pilot (CP) terminal, a protective earth (PE) terminal, and DC input terminals DC+ and DC− may be provided in the inlet.

In addition, according to CCS2, three AC input terminals L1, L2, and L3, a neutral terminal, a PD terminal, a CP terminal, a PE terminal, and DC input terminals DC+ and DC− may be provided in the inlet.

Among the aforementioned terminals, the PD terminal is a terminal for confirming that a connector is fastened to the inlet and is referred to as a fastening confirmation terminal. In addition, the CP terminal is a terminal for communication with an external device and is referred to as a communication terminal.

According to the charging connector standards, an on-board charger (OBC) may convert AC voltage input through an AC input terminal into DC voltage to slowly charge a high-voltage battery or rapidly charge the high-voltage battery through the DC input terminal.

According to the charging connector standards described above, it can be seen that a terminal for supplying control power to an external device is not separately defined.

Therefore, in embodiments of the present disclosure, an AC input terminal for slow charging, among the terminals of the inlet provided in the eco-friendly vehicle, is used as a terminal for supplying control voltage. In embodiments of the present disclosure, CCS1 and CCS2, among the charging connector standards, are described, but embodiments of the present disclosure may also be similarly applied to other charging connector standards (e.g., GB/T HPC, CHADEMO, etc.) including a plurality of terminals for fast charging or slow charging.

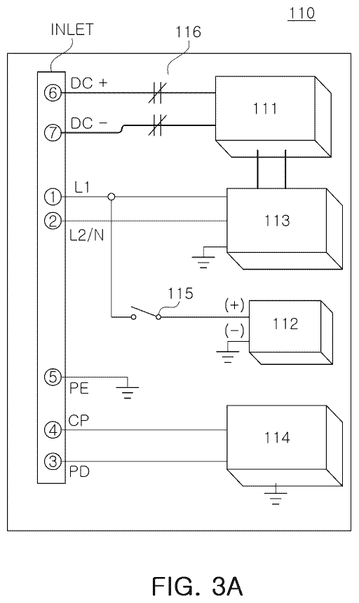

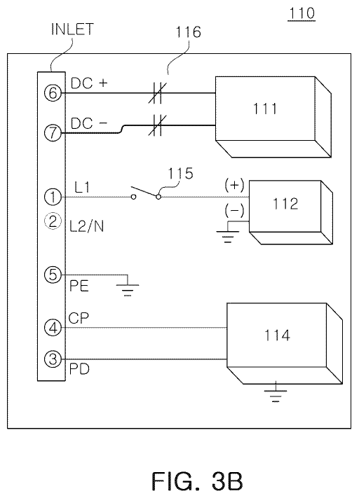

Meanwhile, FIG. 3A is an internal block diagram of a power supply device for an eco-friendly vehicle equipped with an OBC according to an exemplary embodiment of the present disclosure.

As shown in FIG. 3A, the power supply device 110 may include an inlet, a high voltage supply module 111, a low voltage supply module 112, an OBC 113, a control module 114, a first switching module 115, and a second switching module 116. The inlet shown in FIG. 3A complies with the charging connector standards based on CCS1.

First, the high voltage supply module 11 is a high voltage battery supplying high voltage to drive a motor, and the high voltage may be a DC voltage between 400 V and 800 V.

In addition, the low voltage supply module 112 is a module supplying low voltage to an electrical load of an eco-friendly vehicle. The low voltage supply module 112 may be an auxiliary battery or a low DC-DC converter (LDC) receiving high voltage from the high voltage supply module in and converting the same into a 12V or 24V low voltage. Here, the low voltage may be a DC voltage between 12V and 48V.

In addition, as shown in FIG. 3A, the DC input terminals DC+ and DC− of the inlet may be connected to the high voltage supply module 111 through the second switching module 116.

In addition, when any one of the L1 terminal and the L2/N terminal constituting the AC input terminals of the inlet is connected to a positive (+) terminal of the low voltage supply module 112 through the first switching module 115, a negative (−) terminal of the low voltage supply module 112 may be connected to the PE terminal. FIG. 3A illustrates that the L1 terminal is connected to the positive (+) terminal of the low voltage supply module through the first switching module 115.

Also, the CP terminal and the PD terminal may be connected to the control module 114.

Meanwhile, although not shown in the drawing, in the case of CCS1, when any one of the L1 terminal and the L2/N terminal constituting the AC input terminals is connected to the positive (+) terminal of the low voltage supply module 112, the negative (−) terminal of the low voltage supply module 112 may be connected to the other of the L1 terminal and the L2/N terminal. At this time, the first switching module 115 may be provided between any one of the L1 terminal and the L2/N terminal and the positive (+) terminal of the low voltage supply module 112 and between the other of the L1 terminal and the L2/N terminal and the negative (−) terminal of the low voltage supply module 112.

In addition, although not separately shown in the drawing, in the case of CCS2, when the AC input terminal is one of the L1 terminal, the L2 terminal, and the L3 terminal, the negative (−) terminal of the low voltage supply module 112 may be connected to the PE terminal. Similarly, of course, the DC input terminals may be DC+ and DC− terminals, the fastening confirmation terminal may be the PD terminal, and the communication terminal may be the CP terminal.

The aforementioned first switching module 115 and second switching module 116 may be relays or semiconductor switching elements. Semiconductor switching elements may include a field effect transistor (FET), a metal oxide semiconductor FET (MOSFET), an insulated gate bipolar mode transistor (IGBT), a thyristor, a gate turn-off (GTO) thyristor, a triode for alternating current (TRIAC), a silicon controlled rectifier (SCR), and the like.

Of course, the aforementioned first switching module 115 may be in an OFF state when slow charging or fast charging is performed through a slow charging facility or a fast charging facility.

Meanwhile, when a connector of the external device 120 is fastened to the inlet, the control module 114 may turn on the first switching module 115 to supply a control voltage to the external device 120. In addition, the control module 114 may turn on the second switching module 116 to supply the high voltage of the high voltage supply module 111 to the external device 120 or slowly charge the high voltage supply module 111 with a voltage supplied from the external device.

The control module 114 described above may include a processor (e.g., a computer, a microprocessor, a CPU, an ASIC, a logic circuit, etc.) and a memory storing software instructions providing various functions when executed by the processor. Here, the processor and memory may be implemented as separate semiconductor circuits. Alternatively, the processor and the memory may be implemented as a single integrated semiconductor circuit. One or more processors may be provided.

Hereinafter, a process of supplying voltage from the power supply device 110 to the external device 120 is described with reference to FIGS. 1 to 3A.

According to FIGS. 1 to 3A, when the connector of the external device 120 is fastened to the inlet, the control module 114 may turn on the first switching module 115 to supply the control voltage to the external device 120.

Specifically, when it is confirmed that the connector of the external device 120 is fastened to the inlet through the fastening confirmation terminal PE, the control module 114 may turn on the first switching module 115.

Thereafter, when it is confirmed that communication with the external device 120 is normal through the communication terminal CP, the control module 114 may be configured to lock the inlet and the connector of the external device 120 by controlling a locking device (not shown).

Thereafter, when a request for high voltage is received from the external device 120 through the communication terminal CP, the control module 114 may turn on the second switching module 116 to supply high voltage to the external device 120.

Thereafter, when a request for termination of the control voltage is received through the communication terminal CP, the control module 114 may sequentially turn off the second switching module 116 and the first switching module 115 and then control the locking device to unlock between the inlet and the connector of the external device 120.

Meanwhile, FIG. 3B is an internal block diagram of a power supply device for an eco-friendly vehicle not equipped with an OBC according to an exemplary embodiment of the present disclosure.

As shown in FIG. 3B, when any one of the L1 terminal and the L2/N terminal constituting the AC input terminals of the inlet is connected to the positive (+) terminal of the low voltage supply module through the first switching module 115, the negative (−) terminal of the low voltage supply module may be connected to the PE terminal.

In the case of FIG. 3B, control power and high voltage may be supplied to the external device 120 in the same manner as in FIG. 3A, so detailed description thereof is omitted here.

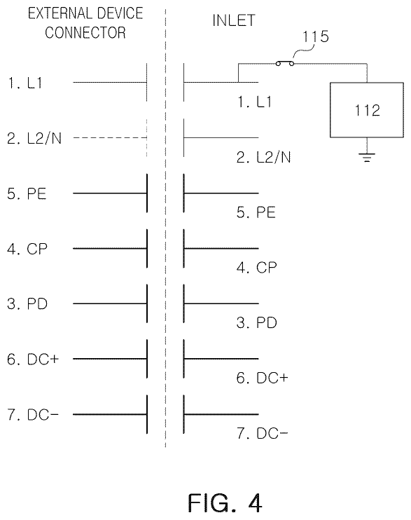

Meanwhile, FIG. 4 is a diagram illustrating an operation of a first switching module when supplying a control voltage to an external device according to an exemplary embodiment of the present disclosure.

As illustrated in FIGS. 1 to 4, when the connector of the external device 120 is fastened to the inlet of the eco-friendly vehicle and the first switching module 115 is turned on, the power supply device 110 may supply a control voltage to the external device 120.

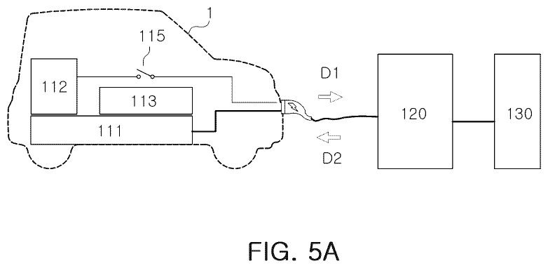

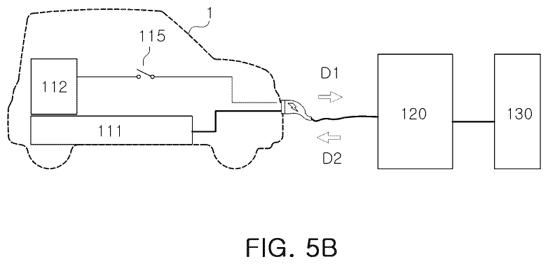

Meanwhile, FIG. 5A is a diagram illustrating that an eco-friendly vehicle equipped with an OBC supplies a high voltage to an external device or the external device charges a high voltage supply module. The external device 120 may be a device requiring a control voltage for operation, and to this end, the first switching module 115 may be turned on.

As shown in FIG. 5A, the external device 120 may provide high voltage to the load 130 (see D1). To this end, the second switching module 116 may be turned on.

In this case, the external device 120 may be a DC/AC converter converting the high voltage from the high voltage supply module 11 into AC voltage and supplying the AC voltage to the load 130, or it may be a DC/DC converter stepping up or stepping down the high voltage from the high voltage supply module 11 and supplying the same to the load 130. The load 130 may be a load for V2X. For example, in a case in which V2X is V2L or V2H, the load 130 may be various electronic devices, in a case in which V2X is V2V, the load 130 may be an eco-friendly vehicle, and in a case in which V2X is V2G, the load 130 may be a power grid.

Alternatively, if the OBC 113 has a low capacity (e.g., 7 kW) or is broken, the high voltage supply module 11 may be slowly charged with high power (see D2) using the external device 120 having a high capacity (e.g., 22 kW). In this case, the external device 120 may be an AC/DC converter converting the AC voltage provided from the load 130 into DC voltage, and the converted DC voltage may directly slowly charge the high voltage supply module 11 through the DC input terminal.

Meanwhile, FIG. 5B is a diagram illustrating that an eco-friendly vehicle not equipped with an OBC supplies a high voltage to an external device or the external device charges a high voltage supply module.

As shown in FIG. 5B, in the case of an eco-friendly vehicle not equipped with an OBC, the external device 120 may provide high voltage to the load 130 (see D1) or slowly charge (see D2) the high voltage supply module 11 with high power using the external device 120 having a high capacity (e.g., 22 kW), in the same manner as in FIG. 5A.

As described above, according to an exemplary embodiment of the present disclosure, control power may be provided to an external device by using the AC input terminal for slow charging, among the terminals of the inlet provided in the eco-friendly vehicle, as a terminal for supplying the control voltage.

According to an exemplary embodiment of the present disclosure, a high-voltage battery mounted on an eco-friendly vehicle may be charged with high power through an external device, regardless of whether the OBC is provided or broken, or a high voltage from a high-voltage battery may be supplied to a load through an external device.

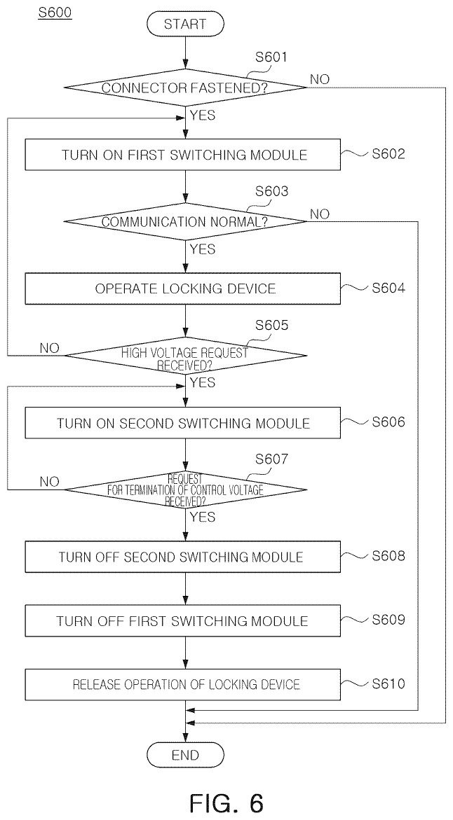

Meanwhile, FIG. 6 is a flowchart illustrating a power supply method of an eco-friendly vehicle according to an exemplary embodiment of the present disclosure.

Hereinafter, a power supply method of an eco-friendly vehicle according to an exemplary embodiment of the present disclosure is described with reference to FIGS. 1 to 6. However, for simplification, the same descriptions as those with FIG. 1 are omitted.

Referring to FIGS. 1 to 6, a power supply method for an eco-friendly vehicle (S600) according to an exemplary embodiment of the present disclosure may start by an operation of determining whether the connector of the external device 120 is fastened to the inlet of the power supply device 110 (S601). As described above, whether the connector is fastened may be determined through the fastening confirmation terminal PE.

If it is determined that the connector of the external device 120 is fastened to the inlet as a result of the determination in operation S601, the power supply device 110 may turn on the first switching module 115 to supply a control voltage to the external device 120 (S602).

Thereafter, the power supply device 110 may determine whether communication with the external device 120 is normal through the communication terminal CP (S603).

If it is determined that communication with the external device 120 is normal as a result of the determination in operation S603, the power supply device 110 may operate a locking device (not shown) to lock the inlet and the connector of the external device 120 (S604).

Thereafter, the power supply device 110 may determine whether a request for high voltage is received from the external device 120 through the communication terminal CP (S605).

If the request for high voltage is received as a result of the determination in operation S605, the power supply device 110 may turn on the second switching module 116 to supply high voltage to the external device 120 (S606).

Thereafter, the power supply device 110 may determine whether a request for termination of the control voltage is received through the communication terminal CP (S607).

If a request for termination of the control voltage is received as a result of the determination in operation S607, the power supply device 110 may sequentially turn off the second switching module 116 and the first switching module 115 and then release the operation of the locking device (S608 to S610).

Meanwhile, if the OBC 113 has a low capacity (e.g., 7 kW) or is broken or if there is no OBC 113, the high voltage supply module 11 may be charged slowly with high power using the external device 120 having a high capacity (e.g., 22 kW) as described above.

As described above, according to an exemplary embodiment of the present disclosure, control power may be provided to the external device by using the AC input terminal for slow charging, among the terminals of the inlet provided in the eco-friendly vehicle, as a terminal for supplying the control voltage.

According to an exemplary embodiment of the present disclosure, a high-voltage battery mounted on an eco-friendly vehicle may be charged with high power through an external device, regardless of whether the OBC is provided or broken, or high voltage of the high-voltage battery may be supplied to the load through an external device.

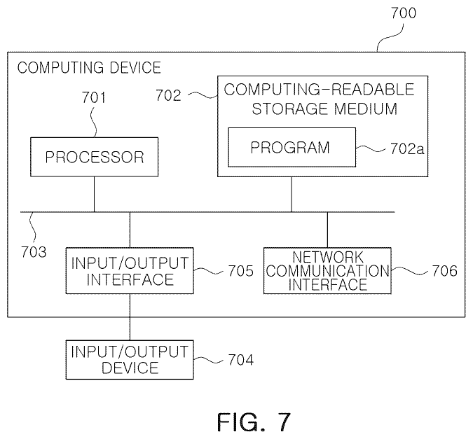

FIG. 7 is a block diagram of a computing device 700 that may fully or partially implement the control module 114 of a power supply according to an exemplary embodiment of the present disclosure.

As shown in FIG. 7, the computing device 700 includes at least one processor 701, a computer-readable storage medium 702, and a communication bus 703.

The processor 701 may enable the computing device 700 to operate according to the aforementioned exemplary embodiment. For example, the processor 701 may execute one or more programs stored in the computer-readable storage medium 702. The one or more programs may include one or more computer-executable instructions, which, when executed by the processor 701, may cause the computing device 700 to perform operations according to exemplary embodiments.

The computer-readable storage medium 702 is configured to store computer-executable instructions or program code, program data, and/or other suitable form of information. A program 702a stored in the computer-readable storage medium 702 includes a set of instructions executable by the processor 701. In an exemplary embodiment, the computer-readable storage medium 702 may include a memory (volatile memory, such as random access memory, non-volatile memory, or appropriate combinations thereof), one or more magnetic disk storage devices, optical disk storage devices, flash memory devices, other types of storage mediums that may be accessed by the computing device 700 and store desired information, or appropriate combinations thereof.

The communication bus 703 interconnects various other components of the computing device 700 including the processor 701 and the computer-readable storage medium 702.

The computing device 700 may also include one or more input/output interfaces 705 and one or more network communication interfaces 706 providing an interface for one or more input/output devices 704. The input/output interface 705 and the network communication interface 706 are connected to the communication bus 703. The network may be one of a cellular network, such as global system for mobile communications (GSM), enhanced data rate for GSM evolution (EDGE), general packet radio service (GPRS), code division multiple access (CDMA), time division-CDMA (TD-CDMA), universal mobile telecommunications system (UMTS), long term evolution (LTE), or another cellular network.

The input/output device 704 may be coupled to other components of the computing device 700 through the input/output interface 705. As an example, the input/output devices 704 include, but are not limited to, a pointing device (such as a mouse or trackpad), a keyboard, a touch input device (such as a touchpad or touch screen), a voice or sound input device, various types of input devices, such as a sensor device, and/or an imaging device, and/or output devices, such as a display device, a printer, a speaker, and/or a network card. As an example, the input/output device 704 may be included in the computing device 700 as a component constituting the computing device 700, or it may be connected to the computing device 700 as a separate device distinct from the computing device 700.

Meanwhile, the exemplary embodiments of the present disclosure may include a program for performing the methods described in this specification on a computer and a computer-readable recording medium including the program. The computer-readable recording medium may include program instructions, local data files, local data structures, etc., alone or in combination. The medium may be those specifically designed and configured for the present disclosure or may be those commonly available in the computer software field. Examples of the computer-readable recording medium include a magnetic medium, such as hard disks, floppy disks, and magnetic tapes, an optical recording medium, such as CD-ROMs, DVDs, and hardware devices specifically configured to store and perform program instructions, such as ROM, RAM, flash memory, etc. Examples of the program may include not only machine language code, such as that generated by a compiler, but also high-level language code that may be executed by a computer using an interpreter or the like.

While example exemplary embodiments have been shown and described above, it will be apparent to those skilled in the art that modifications and variations could be made without departing from the scope of the present disclosure as defined by the appended claims.

What is claimed is:

1. A power supply device of an eco-friendly vehicle, the power supply device comprising:
a low voltage supply module;
an inlet comprising a plurality of terminals for fast charging and slow charging, wherein, among the plurality of terminals, a terminal connected to the low voltage supply module is an alternating current (AC) input terminal for slow charging;
a first switching module disposed between a first terminal of the plurality of terminals and the low voltage supply module; and
a control module configured to turn on the first switching module to supply a control voltage from the low voltage supply module to an external device in a state in which a connector of the external device is connected to the inlet.

2. The power supply device of claim 1, wherein:
the inlet further comprises a fastening confirmation terminal; and
the control module is configured to turn on the first switching module in response to a confirmation that the inlet and the connector of the external device are connected through the fastening confirmation terminal.

3. The power supply device of claim 2, wherein:
the inlet further comprises a communication terminal; and
the control module is configured to control a locking device to lock the inlet and the connector of the external device in response to a confirmation that communication with the external device is normal through the communication terminal.

4. The power supply device of claim 3, further comprising:
a high voltage supply module; and
a second switching module disposed between the high voltage supply module and a direct current (DC) input terminal for fast charging among the plurality of terminals, wherein the control module is configured to turn on the second switching module to supply a high voltage from the high voltage supply module to the external device in response to a request for the high voltage received through the communication terminal.

5. The power supply device of claim 4, wherein the control module is configured to turn off the first switching module and the second switching module and then control the locking device to unlock the inlet and the connector of the external device in response to a request for termination of the control voltage received through the communication terminal.

6. The power supply device of claim 5, wherein the control module is configured to sequentially turn off the second switching module then the first switching module in response to the request for termination of the control voltage.

7. The power supply device of claim 4, wherein the low voltage supply module comprises:
an auxiliary battery configured to supply 12 V or 24 V voltage; or
a low DC-DC converter (LDC) configured to receive a high voltage from the high voltage supply module and convert the received high voltage into 12 V or 24 V voltage.

8. The power supply device of claim 4, wherein the external device comprises:
a DC/AC converter configured to convert a high voltage of the high voltage supply module into AC voltage and supply the AC voltage to an external load; or
a DC/DC converter configured to step up or step down the high voltage of the high voltage supply module and supply the corresponding voltage to the external load.

9. The power supply device of claim 8, wherein the external load comprises a load for vehicle-to-everything (V2X).

10. The power supply device of claim 4, wherein:
the external device comprises an AC/DC converter configured to convert AC voltage to DC voltage; and
the high voltage supply module is configured to be directly charged by the converted DC voltage through the DC input terminal.

11. The power supply device of claim 4, wherein the inlet of the eco-friendly vehicle is compliant with a first charging connector standard or a second charging connector standard, and wherein the first charging connector standard is CCS1 and the second charging connector standard is CCS2.

12. The power supply device of claim 11, wherein, in a state of charging under the first charging connector standard, in an arrangement in which an L1 terminal or an L2/N terminal defining the AC input terminal is connected to a positive (+) terminal of the low voltage supply module, a negative (−) terminal of the low voltage supply module is connected to a protective earth (PE) terminal, the DC input terminals are DC+ and DC− terminals, the fastening confirmation terminal is a proximity detection (PD) terminal, and the communication terminal is a control pilot (CP) terminal.

13. The power supply device of claim 11, wherein, in a state of charging under the first charging connector standard, in an arrangement in which an L1 terminal or an L2/N terminal defining the AC input terminal is connected to a positive (+) terminal of the low voltage supply module, a negative (−) terminal of the low voltage supply module is connected to the other of the L1 terminal and the L2/N terminal, the first switching module is disposed between the L1 terminal or the L2/N terminal and the positive (+) terminal of the low voltage supply module and between the other of the L1 terminal and the L2/N terminal and the negative (−) terminal of the low voltage supply module, the DC input terminals are DC+ and DC− terminals, the fastening confirmation terminal is a proximity detection (PD) terminal, and the communication terminal is a control pilot (CP) terminal.

14. The power supply device of claim 11, wherein, in a state of charging under the second charging connector standard, in an arrangement in which the AC input terminal comprises an L1 terminal, an L2 terminal, or an L3 terminal, a negative (−) terminal of the low voltage supply module is connected to a protective earth (PE) terminal, the DC input terminals are DC+ and DC− terminals, the fastening confirmation terminal is a proximity detection (PD) terminal, and the communication terminal is a control pilot (CP) terminal.

15. The power supply device of claim 4, wherein:
the control voltage is a DC voltage between 12 V and 48 V; and
the high voltage is a DC voltage between 400 V and 800 V.

16. An eco-friendly vehicle comprising:
a power supply module comprising:
a low voltage supply module;
an inlet comprising a plurality of terminals for fast charging and slow charging, wherein, among the plurality of terminals, a terminal connected to the low voltage supply module is an alternating current (AC) input terminal for slow charging;
a first switching module disposed between a first terminal of the plurality of terminals and the low voltage supply module; and
a control module configured to turn on the first switching module to supply a control voltage from the low voltage supply module to an external device in a state in which a connector of the external device is connected to the inlet.

17. The eco-friendly vehicle of claim 16, wherein:
the inlet further comprises a fastening confirmation terminal; and
the control module is configured to turn on the first switching module in response to a confirmation that the inlet and the connector of the external device are connected through the fastening confirmation terminal.

18. The eco-friendly vehicle of claim 17, wherein:
the inlet further comprises a communication terminal; and
the control module is configured to control a locking device to lock the inlet and the connector of the external device in response to a confirmation that communication with the external device is normal through the communication terminal.

19. The eco-friendly vehicle of claim 18, further comprising:
a high voltage supply module; and
a second switching module disposed between the high voltage supply module and a direct current (DC) input terminal for fast charging among the plurality of terminals, wherein the control module is configured to turn on the second switching module to supply a high voltage from the high voltage supply module to the external device in response to a request for the high voltage received through the communication terminal.

20. The eco-friendly vehicle of claim 19, wherein, in a state in which the inlet of the eco-friendly vehicle complies with a first charging connector standard or a second charging connector standard, the first charging connector standard being CCS1 and the second charging connector standard being CCS2, and in an arrangement in which an L1 terminal or an L2/N terminal defining the AC input terminal is connected to a positive (+) terminal of the low voltage supply module, a negative (−) terminal of the low voltage supply module is connected to a protective earth (PE) terminal, the DC input terminals are DC+ and DC− terminals, the fastening confirmation terminal is a proximity detection (PD) terminal, and the communication terminal is a control pilot (CP) terminal.
